(19) United States
(12) Patent Application Publication
(10) Pub. No.: US 2023/0226864 A1
(43) Pub. Date: Jul. 20, 2023

(54) CONTROL APPARATUS FOR ELECTRICALLY-OPERATED VEHICLE

(71) Applicant: TOYOTA JIDOSHA KABUSHIKI KAISHA, Toyota-shi (JP)

(72) Inventors: Seiji MASUNAGA, Toyota-shi (JP); Shingo ETO, Gamagori-shi (JP); Yoshio HASEGAWA, Chiryu-shi (JP); Shingo OKAYA, Susono-shi (JP)

(73) Assignee: TOYOTA JIDOSHA KABUSHIKI KAISHA, Toyota-shi (JP)

(21) Appl. No.: 18/087,131

(22) Filed: Dec. 22, 2022

(30) Foreign Application Priority Data
Jan. 14, 2022 (JP) 2022-004655

(51) Int. Cl. B60D 1/26; B60D 1/62; B60W 30/182

(52) U.S. Cl. CPC B60D 1/26; B60D 1/62; B60W 30/182; B60W 2510/081; B60W 2510/083

(57) ABSTRACT

A control apparatus for an electrically-operated vehicle that includes an electric motor serving as one of at least one drive power source. The control apparatus includes a vibration-suppression control portion configured to execute a vibration suppression control for causing the electric motor to output a vibration suppression torque by which vibration of the electrically-operated vehicle is to be suppressed. The vibration-suppression control portion is configured to determine whether the electrically-operated vehicle is in a towing state in which the electrically-operated vehicle runs while towing a towed vehicle, or not, and is configured to make a vibration suppression capacity of the vibration suppression control higher when determining that the electrically-operated vehicle is in the towing state, than when determining that the electrically-operated vehicle is not in the towing state.

This application claims priority from Japanese Patent Application No. 2022-004655 filed on Jan. 14, 2022, the disclosure of which is herein incorporated by reference in its entirety.

### FIELD OF THE INVENTION

The present invention relates to a control apparatus for an electrically-operated vehicle, and more particularly, to techniques of executing a vibration suppression control by causing an electric motor to output a vibration suppression torque.

### BACKGROUND OF THE INVENTION

There are proposed techniques of causing a cooling device to cool an electric-power storage device provided in an electrically-operated vehicle that includes an electric motor as a drive power source. In the proposed techniques, it is determined whether or not the electrically-operated vehicle is in a towing state in which the electrically-operated vehicle runs while towing a towed vehicle, and a cooling capacity of the cooling device is made higher when the electrically-operated vehicle is in the towing state, than the electrically-operated vehicle is not in the towing state (see JP-2021-83217A). Further, WO2014/054668 and JP-2019-126201A disclose techniques of executing a vibration suppression control by causing the electric motor to output a vibration suppression torque for suppressing vibration of the electrically-operated vehicle, and changing a control gain of the vibration suppression control, depending on magnitude of request for acceleration of the electrically-operated vehicle.

### SUMMARY OF THE INVENTION

By the way, when the electrically-operated vehicle runs while towing the towed vehicle such as a trailer, vibration could be generated between the electrically-operated vehicle and the towed vehicle, apart from vibration generated in the electrically-operated vehicle itself. If a resonance frequency of the vibration generated between the two vehicles is close to a resonance frequency of the vibration generated in the electrically-operated vehicle itself, the vibration of the electrically-operated vehicle could be increased due to resonance of the vibrations.

The present invention was made in view of the background art described above. It is therefore an object of the present invention to suppress increase of vibration of the electrically-operated vehicle, wherein the increase of the vibration could be caused by vibration generated between the electrically-operated vehicle and the towed vehicle when the electrically-operated vehicle runs while towing the towed vehicle.

The object indicated above is achieved according to the following aspects of the present invention.

According to a first aspect of the invention, there is provided a control apparatus for an electrically-operated vehicle that includes an electric motor serving as one of at least one drive power source. The control apparatus includes a vibration-suppression control portion configured to execute a vibration suppression control for causing the electric motor to output a vibration suppression torque by which vibration of the electrically-operated vehicle is to be suppressed, The vibration-suppression control portion is configured to determine whether the electrically-operated vehicle is in a towing state in which the electrically-operated vehicle runs while towing a towed vehicle, or not, and is configured to make a vibration suppression capacity of the vibration suppression control higher when determining that the electrically-operated vehicle is in the towing state, than when determining that the electrically operated vehicle is not in the towing state. For example, the vibration-suppression control portion may be configured to calculate the vibration suppression torque, based on fluctuation of a rotational speed of a rotary member constituting a power transmission apparatus of the electrically-operated vehicle, such that the fluctuation of the rotational speed is reduced by the vibration suppression torque outputted by the electric motor.

According to a second aspect of the invention, in the control apparatus according to the first aspect of the invention, the vibration-suppression control portion is configured to execute a feedback control of the vibration suppression torque, and is configured to make a control gain of the feedback control higher when determining that the electrically-operated vehicle is in the towing state, than when determining that the electrically-operated vehicle is not in the towing state.

In the control apparatus according to either the first or second aspect of the invention, the vibration suppression capacity of the vibration suppression control is made higher when the electrically-operated vehicle is in the towing state than when the electrically-operated vehicle is not in the towing state, so that the vibration of the electrically-operated vehicle itself is appropriately reduced by the vibration suppression control. Therefore, it is possible to suppress increase of the vibration of the electrically-operated vehicle, which could be caused due to resonance of the vibration of the electrically-operated vehicle itself and vibration generated between the electrically-operated vehicle and another vehicle, i.e., towed vehicle. On the other hand, the increase of the vibration suppression capacity of the vibration suppression control increases control width and change of the vibration suppression torque and accordingly increases an electric power consumed by the electric motor. However, although being increased when the electrically-operated vehicle is in the towing state, the vibration suppression capacity is kept low when the electrically-operated vehicle is not in the towing state, so that increase of an electric cost due to the increase of the vibration suppression capacity can be suppressed to a minimally required amount.

In the control apparatus according to the second aspect of the invention, the vibration of the electrically-operated vehicle is to be suppressed by feedback-controlling the vibration suppression torque of the electric motor, such that the control gain of the feedback control is increased so as to increase the vibration suppression capacity when the electrically-operated vehicle is in the towing state. Therefore, when the electrically-operated vehicle is in the towing state, the vibration of the electrically-operated vehicle itself is quickly reduced, so that it is possible to suppress increase of the vibration of the electrically-operated vehicle, which could be caused due to the resonance of the vibrations.

### BRIEF DESCRIPTION OF THE DRAWINGS

FIG. 1 is a view schematically showing a construction of a drive system of a hybrid electrically-operated vehicle including a control apparatus in the form of an electronic control apparatus as an embodiment of the present invention, together with major portions of control functions and systems for executing various kinds of controls in the hybrid electrically-operated vehicle;

FIG. 2 is a flow chart showing a control routine to be executed by the vibration-suppression control portion that is functionally included in the electronic control apparatus of the hybrid electrically-operated vehicle of FIG. 1, so as to set a control gain depending on whether a towing mode is being established or not;

FIG. 3 is a view schematically showing a towing state in which another vehicle (owed vehicle) is coupled to the hybrid electric vehicle of FIG. 1.

### DETAILED DESCRIPTION OF PREFERRED EMBODIMENT

The present invention is applied to the electrically-operated vehicle, which is preferably a front/rear-wheel drive vehicle in which front and rear wheels are to be driven by at least one drive power source including an electric motor. However, the electrically-operated vehicle may be also either a rear-wheel drive vehicle in which only rear wheels are to be driven or a front-wheel drive vehicle in which only front wheels are to be driven. Where the electrically-operated vehicle is the front/rear-wheel drive vehicle, the at least one drive power source may include two drive power sources, such that the front wheels are to be driven by one of the two drive power sources while the rear wheels are to be driven by the other of the two drive power sources. The electrically-operated vehicle may be either an electric vehicle including only drive power source in the form of an electric motor, or a parallel-type or series-type hybrid electrically-operated vehicle including drive power sources in the form of an electric motor and an engine (internal combustion engine). Although the electric motor is constituted advantageously by a motor generator serving as an electric motor and also an electric power generator, it may be constituted also by an electric motor without function serving as an electric power generator. The electrically-operated vehicle may include a plurality of electric motors and/or a plurality of motor generators. Further, the electrically-operated vehicle may include a fluid transmission device and/or transmission, as needed, which are provided in a power transmission path between at least one drive power source and drive wheels.

The vibration suppression control for suppressing the vibration of the electrically-operated vehicle may be executed, for example, by suppressing tortional vibration (rotational fluctuation) a drive system of the electrically-operated vehicle. However, the vibration suppression control may be executed in any other manners, too. For example, the vibration suppressing torque of the electric motor may be controlled such that vibration of a vehicle body (i.e., body of the electrically-operated vehicle) is suppressed. Where feedback-controlling the vibration suppression torque outputted by the electric motor, the vibration-suppression control portion may be configured to change the control gain of the feedback control so as to change the vibration suppression capacity. However, the vibration suppression capacity may he changed in any one of various manners, too. For example, it is possible to prepare a plurality of arithmetic expressions, maps or the like, and to use one of the arithmetic expressions, maps or the like, which is selected depending on whether the electrically-operated vehicle is in the towing state or not. The vibration suppression torque may be also feedforward-controlled rather than being feedback-controlled. That is, the vibration suppression control may be executed in any one of various manners.

### EMBODIMENT

There will be described an embodiment of the present invention in details with reference to drawings. It is noted that figures of the drawings are simplified or deformed as needed, and each portion is not necessarily precisely depicted in terms of dimension ratio, angle, shape, etc.

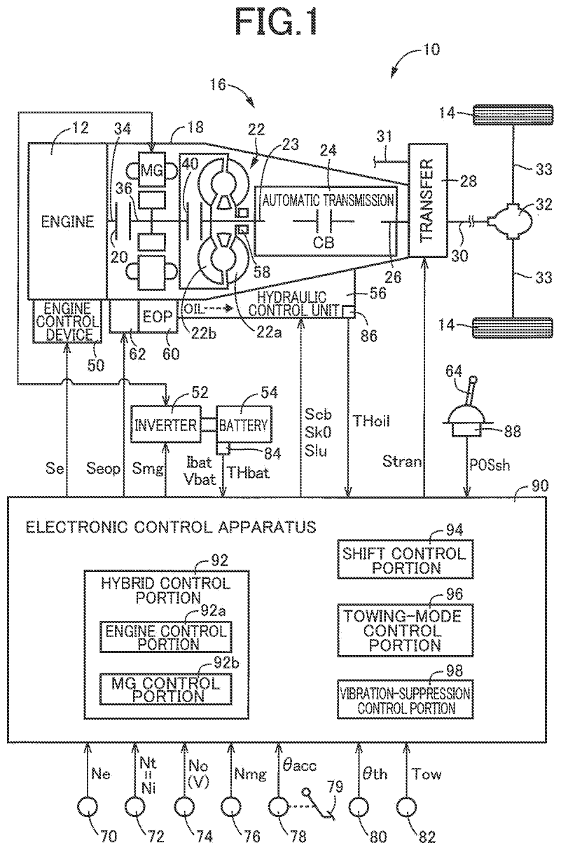

FIG. 1 is a view schematically showing a construction of a drive system of a hybrid electrically-operated. vehicle 10 (hereinafter simply referred to as “vehicle 10”) including an electronic control apparatus 90 as an embodiment of the present invention, together with major portions of control functions and systems for executing various kinds of controls in the vehicle 10. As shown in FIG. 1, the vehicle 10 is a parallel-type hybrid electrically-operated vehicle including an engine 12 and a rotating machine MG as drive power sources for driving the vehicle 10. The vehicle 10 is a front/rear-wheel drive vehicle, i.e., a four-wheel drive vehicle that includes a power transmission apparatus 16 for a front/rear wheel drive, such that an output of each of the engine 12 and the rotating machine MG as the drive power sources is transmitted to an automatic transmission 24 through a torque converter 22 as a fluid transmission device and a turbine shaft 23, and is then distributed to rear and front wheels 14, 15 of the vehicle 10 by a transfer 28 for distributing the output toward the rear and front wheels 14, 15. A drive force distributed toward the rear wheels 14 is transmitted to the rear left and right wheels 14 through a rear output shaft 30, a rear differential gear device 32 and rear drive shafts 33, for example. A drive force distributed toward the front wheels 15 is transmitted to the front left and right wheels 15 (see FIG. 3) through a front output shaft 31 and a rear differential gear device (not shown), for example.

The engine 12 is an internal combustion engine such as gasoline engine and diesel engine. The vehicle 10 is provided with an engine control device 50 that includes a throttle actuator, a fuel injection device and an ignition device. With the engine control device 50 being controlled by the electronic control apparatus 90, an engine torque Te, which is an output torque of the engine 12, is controlled. The rotating machine MG is a motor generator having a function serving as an electric motor configured to generate a mechanical power from an electric power and a function serving as an electric power generator configured to generate an electric power from a mechanical power. The rotating machine MG is a three-phase AC synchronous motor, for example, and is connected to a battery 54 provided in the vehicle 10, through an inverter 52 provided in the vehicle 10. The inverter 52 is controlled by the electronic control apparatus 90 whereby an MG torque Tmg as a torque of the rotating machine MG and an MG rotational speed Nmg as a rotational speed of the rotating machine MG are controlled. The rotating machine MG receives the electric power from the battery 54 through the inverter 52, and generates a drive power for driving the vehicle 10, in place of or in addition to the engine 12. Further, when being driven and rotated by the power of the engine 12 or by a driven power inputted from the drive wheels 14, 15, the rotating machine MG is subjected to the regenerative control so as to serve as the electric power generator for generating the electric power, and so as to generate a regenerative brake if being connected to the drive wheels 14, 15. The electric power generated by the rotating machine MG is stored in the battery 54 through the inverter 52. The battery 54 serves as an electric storage device configured to receive and supply the electric power from and to the rotating machine MG.

The power transmission apparatus 16 includes a casing 18, a K0 clutch 20, the torque converter 22 and the automatic transmission 24. In the casing 18 that is a non-rotary member attached to a body of the vehicle 10, the engine 12, the K0 clutch 20, the torque converter 22 and the automatic transmission 24 are arranged in a series in this order of description in a direction away from the engine 12. The rotating machine MG is disposed between the K0 clutch and the torque converter 22 in a power transmission path between the engine 12 and the drive wheels 14, 15. The K0 clutch 20 is an engine connecting/disconnecting device that is disposed between the engine 12 and the rotating machine MG in the power transmission path, so as to selectively connect and disconnect the engine 12 to and from the rotating machine MG and the power transmission apparatus 16. The torque converter 22 is a fluid transmission device that is disposed between the rotating machine MG and the automatic transmission 24 in the in the power transmission path, so as to transmit the power through a working fluid OIL. The torque converter 22 is connected to the engine 12 through the K0 clutch 20, The automatic transmission 24 is connected to the torque converter 22, and is disposed between the drive power sources (the engine 12 and the rotating machine MG) and the drive wheels 14, 15 and arranged in series with the torque converter 22. The power transmission apparatus 16 further includes an engine connection shaft 34 connecting between the engine 12 and the K0 clutch 20, and an MG connection shaft 36 connecting between the K0 clutch 20 and the torque converter 22. The MG connection shaft 36 is connected to a rotor of the rotating machine MG.

The K0 clutch 20 is, for example, a wet-type or dry-type frictional engagement device (wet-type frictional engagement device in the present embodiment) constituted by a multiple-disc type or single-disc type clutch that is to be pressed by a hydraulic actuator. A K0 torque Tk0 as a torque capacity of the K0 clutch 20 is changed by a regulated K0 hydraulic pressure Pk0 supplied to the K0 clutch 20 from a hydraulic control unit (hydraulic control circuit) 56, whereby a control or operation state of the K0 clutch 20 is switched between an engaged state and a released state, for example. When the K0 clutch 20 is in the engaged state, the rotor of the rotating machine MG and a pump impeller 22a of the torque converter 22 are rotatable integrally with the engine 12 through the engine connection shaft 34. When the K0 clutch 20 is in the released state, transmission of the power between the engine 12 and the rotor of the rotating machine MG and the pump impeller 22a of the torque converter 22 is disconnected, whereby the engine 12 can be stopped.

The torque converter 22 includes the above-described pump impeller 22a connected to the MG connection shaft 36 and a turbine impeller 22b connected to the turbine shaft 23 as an input rotary member of the automatic transmission 24. The pump impeller 22a is connected to the engine 12 though the K0 clutch 20, and is connected directly to the rotating machine MG. The pump impeller 22a is an input member of the torque converter 22 while the turbine impeller 22b is an output member of the torque converter 22. The MG connection shaft 36 serves also as an input rotary member of the torque converter 22. The turbine shaft 23 serves also an output rotary member of the torque converter 22. The torque converter 22 further includes an LU (lockup) clutch 40 that is configured to selectively connect and disconnect between the pump impeller 22a and the turbine impeller 22b. The LU clutch 40 is a known lockup clutch, i.e., a direct clutch provided to connect between the input and output members of the torque converter 22.

An LU clutch torque Tlu as a torque capacity of the LU clutch 40 is changed by a regulated LU hydraulic pressure PRlu supplied to the LU clutch 40 from the hydraulic control unit 56, whereby a control or operation state of the LU clutch 40 is switched among a fully released state, a slipping state and a fully engaged state, in the fully released sate, the LU clutch 40 is released whereby the torque converter 22 is placed in a torque-convener state providing a torque boosting effect. In the slipping state, the LU clutch 40 is engaged while slipping. In the fully engaged state that is a lockup state, the LU clutch 40 is engaged whereby the pump impeller 22a and the turbine impeller 22b of the torque converter 22 are to be rotated integrally each other.

LU clutch torque Tlu as a torque capacity of the LU clutch 40 is changed by a regulated LU hydraulic pressure PRlu supplied to the LU clutch 40 from the hydraulic control unit 56, whereby a control or operation state of the LU clutch 40 is switched among a fully released state, a slipping state and a fully engaged state. In the fully released sate, the LU clutch 40 is released whereby the torque converter 22 is placed in a torque-converter state providing a torque boosting effect. In the slipping state, the LU clutch 40 is engaged while slipping. In the fully engaged state that is a lockup state, the LU clutch 40 is engaged whereby the pump impeller 22a and the turbine impeller 22b of the torque converter 22 are to he rotated integrally with each other.

The automatic transmission 24 is a known planetary-gear-type automatic transmission including at least one planetary gear device and a plurality of engagement devices CB. Each of the engagement devices CB is a hydraulically-operated frictional engagement device in the form of a multiple-disc type or a single-disc type clutch or brake that is to be pressed by a hydraulic actuator, or a band brake that is to be tightened by a hydraulic actuator, for example. Each of the engagement devices CB is configured to receive a CB hydraulic pressure Pcb that is a regulated hydraulic pressure supplied from the hydraulic control unit 56, whereby a CB torque Tcb, i.e., torque capacity of the engagement device CB is changed and its controlled or operation state is switched between an engaged state and a released state, for example.

The automatic transmission 24 is a step-variable automatic transmission configured to establish a selected one of a plurality of gear positions, with a corresponding one or ones of the engagement devices CB being engaged, wherein the gear positions are different from each other in gear ratio (speed ratios γ (=input rotational speed Ni/output rotational speed No), and wherein the plurality of gear positions include a plurality of forward-drive gear positions and a reverse-drive gear position. The automatic transmission 24 is configured to switch from one of the gear positions to another one of the gear positions, namely, to establish one of the gear positions which is selected, by the electronic control apparatus 90, depending on, for example, an acceleration operation made by a vehicle driver (operator) and a running speed V of the vehicle 10. With all of the engagement devices CB being released, the automatic transmission 24 is placed in a neutral state in which transmission of the power is disconnected. The input rotational speed Ni is a rotational speed of the turbine shaft 23, and is an input rotational speed of the automatic transmission 24. The input rotational speed Ni is also a rotational speed of the output member of the torque converter 22, and is equal to a turbine rotational speed Nt that is an output rotational speed of the torque converter 22. The output rotational speed No is a rotational speed of an intermediate shaft 26 as output shaft of the automatic transmission 24, and is an output rotational speed of the automatic transmission 24.

The transfer 28 includes an auxiliary transmission configured to change a speed of rotation transmitted to the intermediate shaft 26 from the automatic transmission 24 at a selected one of two change rates (i.e., transfer Hi and transfer Lo) that are to be switched by an high/low switch device, a distribution mechanism configured to distribute the drive power outputted from the auxiliary transmission, to the rear and front output shafts 30, 31 at a variable distribution ratio, a differential lock device configured to limit differential rotation between the rear and front output shafts 30, 31, and a 2WD/4WD switch device configured to switch between 2WD drive (in which only the rear drive wheels 14 are to be driven) and 4WD drive (in which the rear and front drive wheels 14, 15 are to be driven). The high/low switch device of the auxiliary transmission, the differential lock device and the 2WD/4WD switch device are electrically controlled by the electronic control apparatus 90. The transfer 28 may be configured also to electrically control the distribution ratio of the drive power to the rear and front output shafts 30, 31.

In the power transmission apparatus 16, the power outputted from the engine 12 is transmitted to the drive wheels 14, 15 sequentially through the engine connection shaft 34, K0 clutch 20, MG connection shaft 36, torque converter 22 and automatic transmission 24 and transfer 28, when the K0 clutch 20 is engaged. Further, the power outputted from the rotating machine MG is transmitted to the drive wheels 14, 15 sequentially through the MG connection shaft 36, torque converter 22 and automatic transmission 24 and transfer 28, regardless of whether the K0 clutch 20 is engaged or released.

The vehicle 10 includes an MOP 58 that is a mechanical fluid pump (mechanical oil pump), an EOP 60 that is an electric fluid pump (electric oil pump) and a pump motor 62. The MOP 58 is connected to the pump impeller 22a, so as to be driven and rotated by the drive power sources (engine 12 and rotating machine MG) for outputting the working fluid OIL that is used in the power transmission apparatus 16. The pump motor 62 is an electric motor exclusively serving to drive and rotate the EOP 60. The EOP 60 is to be driven and rotated by the pump motor 62 so as to output the working fluid OIL at a desired timing, for example, during stop of the vehicle 10. The working fluid OIL outputted by the MOP 58 and/or EOP 60 is supplied to the hydraulic control unit 56. The hydraulic control unit 56 outputs the CB hydraulic pressure Pcb, K0 hydraulic pressure Pk0 and LU hydraulic pressure Plu that have been regulated based on the working fluid OIL outputted by the MOP 58 and/or EOP 60. The working fluid OIL is supplied to the torque converter 22 so as to be used for transmitting the power, and is used for lubricating and cooling various parts of the power transmission apparatus 16. The working fluid OIL is stored in a fluid storage portion such as an oil pan, which is provided below the casing 18, and the stored working fluid OIL is pumped by the MOP 58 and/or the EOP 60 so as to be supplied to the hydraulic control unit 56. The hydraulic control unit 56 is provided with a plurality of solenoid valves which are to be controlled by the electronic control apparatus 90 so as to control hydraulic pressure in various parts and switch hydraulic passages.

The vehicle 10 is provided with the electronic control apparatus 90 as a control apparatus that is configured to perform various control operations. The electronic control apparatus 90 includes a so-called microcomputer incorporating a CPU, a ROM, a RAM and an input-output interface. The CPU performs the various control operations of the vehicle 10, by processing various input signals, according to control programs stored in the ROM, while utilizing a temporary data storage function of the RAM, The electronic control apparatus 90 includes a plurality of computers such as an engine control computer, an MG control computer and a hydraulic control computer, as needed.

The electronic control apparatus 90 receives various input signals based on values detected by respective sensors provided in the vehicle 10. Specifically, the electronic control apparatus 90 receives: an output signal of an engine speed sensor 70 indicative of an engine rotational speed Ne that is a rotational speed of the engine 12; an output signal of a turbine speed sensor 72 indicative of a turbine rotational speed Nt that is equal to the AT input rotational speed Ni; an output signal of an output speed sensor 74 indicative of the AT output rotational speed No corresponding to the vehicle running speed V; an output signal of an MG speed sensor 76 indicative of the motor rotational speed Nm; an output signal of an accelerator-opening degree sensor 78 indicative of the accelerator opening degree (accelerator operation degree) θacc representing the amount of accelerating operation made by the vehicle driver; an output signal of a throttle-opening degree sensor 80 indicative of a throttle opening degree θth which is an opening degree of an electronic throttle valve; an output signal of a towing mode switch 82 which is a towing mode signal Tow indicating that the towing mode switch 82 is placed in an ON state; an output signal of a battery sensor 84 indicative of a battery temperature THbat, a battery charging/discharging electric current Ibat and a battery voltage Vbat; an output signal of a fluid temperature sensor 86 indicative of a working-fluid temperature THoil that is a temperature of the working fluid OIL in the hydraulic control unit 56; and an output signal of a lever position sensor 88 indicative of an operation position (lever position) POSsh of a shift lever 64 provided in the vehicle 10. The towing mode switch 82 is a switch that is to be operated by the vehicle driver to select a towing mode control suitable for a towing drive, when the vehicle 10 is to be driven to run while towing a towed vehicle 112 (e.g., trailer) coupled to a rear end portion of the vehicle 10 through a hitch member 110 that is fixed to the rear end portion of the vehicle 10. The towing mode switch 82 is an ON-OFF switch that is disposed in vicinity of a driver seat of the vehicle 10.

The shift lever 64 is disposed in vicinity of the driver seat of the vehicle 10, and is a shift operating member that is to be operated by the vehicle driver so as to switch a shift range in which the power is transmittable in the automatic transmission 24. The shift lever 64 is to be placed by the vehicle driver into one of the operation positions POSsh that include a P position, an R position, a N position and a D position. When the shift lever 64 is placed in the P position, the automatic transmission 24 is placed in a neutral state in which the transmission of the power is disconnected and a P (parking) range is selected to mechanically inhibit rotation of the intermediate shaft 26, wherein the neutral state is a state in which all of the engagement devices CB are released, for example. When the shift lever 64 is placed in the R position, an R (reverse) range is selected to establish the reverse-drive gear position in the automatic transmission 24. When the shift lever 64 is placed in the N position, the automatic transmission 24 is placed in the neutral state (as when the shift lever 64 is placed in the P position) and a N (neutral) range is selected. When the shift lever 64 is placed in the D position, a) (drive) range is selected to establish one of the four forward-drive gear positions 1st-4th which is to be automatically selected depending on an operation state such as the vehicle running speed V and the accelerator opening degree θacc, so as to drive the vehicle 10 with the selected one of the forward-drive gear positions. The shift lever 64 may be of a position-holding type so that the shift lever 64 is held in one of the operation positions POSsh into which the shift lever 64 has been placed. However, the shift lever 64 may be an automatic return type so that the shift lever 64 is automatically returned to a predetermined home position from one of the operation positions POSsh into which the shift lever 64 has been placed.

The electronic control apparatus 90 generates various output signals to the various devices provided in the vehicle 10, such as: an engine control command signal Se that is to be supplied to the engine control device 50 for controlling the engine 12, an MG control command signal Sm that is to be supplied to the inverter 52 for controlling the rotating machine MG; a CB hydraulic control command signal Scb that is to he supplied to the hydraulic control unit 56 for controlling the operation states of the engagement devices CB; a K0 hydraulic control command signal Sko that is to be supplied to the hydraulic control unit 56 for controlling the K0 clutch 20; an LU hydraulic control command signal Slu that is to be supplied to the hydraulic control unit 56 for controlling the operation state of the LU clutch 40; an EOP control command signal Seop that is to be supplied to the pump motor 62 for operating the EOP 60; and a transfer control command signal Stran that is to be supplied to the transfer 28 for controlling the high/low switch device of the auxiliary transmission, the differential lock device and the 2WD/4WD switch device.

For performing various controls in the vehicle 10, the electronic control apparatus 90 functionally includes a hybrid control portion 92, a shift control portion 94 and a towing-mode control portion 96 and a vibration-suppression control portion 98.

The hybrid control portion 92 has a function of controlling cooperative operations of the engine 12 and the rotating machine MG, and includes an engine control portion 92a configured to control the engine 12 and an MG control portion 92b configured to control the rotating machine MG. The hybrid control portion 92 calculates the drive request amount requested to the vehicle 10 by the vehicle driver, by applying the accelerator opening degree θacc and the vehicle running speed V to a drive request amount map, for example, wherein the drive request amount is a requested drive torque Trdem that is to be applied to the rear and front drive wheels 14 15, for example. The hybrid control portion 92 obtains a requested TC input torque Ttcdem that is a required value of the input torque required to be inputted to the torque converter 22 for realizing the requested drive torque Trdem, for example, by taking account of various factors such as a transmission loss, an auxiliary load, the gear ratio γ of the automatic transmission 24 and a maximum chargeable amount Win and a maximum dischargeable amount Wout of the battery 54, and outputs the engine control command signal Se and the MG control command signal Smg for controlling the engine 12 and the rotating machine MG, respectively, such that the requested TC input torque Ttcdem can be obtained. The maximum chargeable amount Win and the maximum dischargeable amount Wout of the battery 54 are calculated, by the electronic control apparatus 90, based on the battery temperature THbat and the charged state value SOC [%] of the batter 54, for example. The charged state value SOC of the battery 54 is a value indicative of a charged state of the battery 54, i.e., an amount of the electric power stored or remaining in the battery 54, and is calculated by the electronic control apparatus 90, for example, based on the charging/discharging electric current Ibat and the voltage Vbat of the battery 54.

When the requested TC input torque Ttcdem can be covered by only the output of the rotating machine MG, the hybrid control portion 92 establishes a BEV (Battery Electric Vehicle) mode as a motor driving mode for causing the vehicle 10 to run by driving the rotating machine MG with only the electric power supplied from the battery 54. In the BEV mode, a BEV driving is performed to drive the vehicle 10 by using only the rotating machine MG as the drive power source while stopping the engine 12 with the K0 clutch 20 being placed in the released state. In the BEV mode, the MG torque Tmg is controlled such that the requested TC input torque Ttcdem is realized. When the requested TC input torque Ttcdem cannot be covered without using at least the output of the engine 12, the hybrid control portion 92 establishes an HEV (Hybrid Electric Vehicle) mode as an engine driving mode for causing the vehicle 10 to run by using at least the engine 12 as the drive power source while placing the K0 clutch 20 in the engaged state. In the HEV mode, the engine torque Te is controlled to realize all or a part of the requested TC input torque Ttcdem by the engine torque Te, and the MG torque Tmg is also controlled to compensate an insufficiency of the engine torque Te to the requested TC input torque Ttcdem, as needed. On the other hand, even when the requested TC input torque Ttcdem can be covered by only the output of the rotating machine MG, the hybrid control portion 92 establishes the HEV mode, for example, in a case in which the engine 12 or other parts of the power transmission apparatus 16 is required to be warmed up. Thus, the hybrid control portion 92 is configured, during the HEV driving, to automatically stop the engine 12 and to restart the engine 12 after having stopped the engine 12, and is configured, during the BEV driving, to start the engine 12 and to automatically stop and start the engine 12 when the vehicle 10 is being stopped. Thus, the hybrid control portion 92 switches between the BEV mode and the HEV mode, depending on the requested TC input torque Ttcdem or the like.

The shift control portion 94 is configured, when the D range is selected, to determine whether a shifting action is required or not in the automatic transmission 24, by using a shifting map or the like that is preformulated with variables (relating to an operation state of the vehicle 10) such as the vehicle running speed V and the accelerator opening degree θacc, and to execute an automatic shift control for outputting the CB hydraulic control command signal Scb, as needed, by which a currently established one of the forward-drive gear positions is to be automatically switched to another one of the forward-drive gear positions in the automatic transmission 24, such that the outputted the CB hydraulic control command signal Scb is supplied to the hydraulic control unit 56. Further, when the shift lever 64 or other manual-shift operating member disposed in vicinity of the driver seat of the vehicle 10 is operated by the vehicle driver and a shift command signal is supplied to the shift control portion 94, the shift control portion 94 is configured to execute a manual shift control by which a currently established one of the forward-drive gear positions is to be switched to another one of the forward-drive gear positions in the automatic transmission 24, in accordance with the shill command signal.

Moreover, when one of the operation positions POSsh is switched to another one of the operation positions POSsh by operation of the shift lever 64, the shift control portion 94 is configured to execute a so-called “garage control” for switching the shift range of the automatic transmission, in accordance with the another one of the operation positions POSsh. In the garage control, when a reverse shift operation is executed, namely, when the shift lever 64 is placed from one of the D position and the R position into the other of the D position and the R position, a reverse range switch is executed to switch the automatic transmission 24 from one of the D range and the R range to the other of the D range and the R range, in accordance with the executed reverse shift operation. Further, in the garage control, other various range switches are executed to switch the automatic transmission 24 from one of non-driving ranges (i.e., P range and N range) and driving ranges (i.e., D range and R range) to another range.

The towing-mode control portion 96 is configured to execute the towing mode control suitable for the towing drive, when the towing mode switch 82 is operated by the vehicle driver to be placed in the ON state and the towing mode signal Tow is supplied to the electronic control apparatus 90, for performing the towing drive with the towed vehicle 112 being coupled to the hitch member 110, as shown in FIG. 3. The towing mode control is executed to control the drive power and the shifting action of the automatic transmission 24, for example, in manners suitable for the towing drive, such that the drive power is increased even without increase of the accelerator opening degree θacc because a drive load applied to the vehicle 10 is increased in the towing drive. For example, as the drive request amount map for calculating the requested drive torque Trdem, based on the accelerator opening degree θacc and the vehicle running speed V, it is possible to prepare a towing-case map in which the accelerator opening degree θacc is offset to smaller degree side, so that the requested drive torque Trdem is calculated to a large torque value even when the accelerator opening degree θacc is a small degree value, and the torques of the engine 12 and the rotating machine MG are controlled based on the requested drive torque Trdem calculated to the large torque value. Further, in the shifting map for the automatic transmission 24, each shifting line is offset to a higher running speed side so that a shift-up action is less likely to be executed while a shift-down action is more likely to be executed, thereby more frequently establishing lower gear positions providing higher gear ratios so as to quickly obtain larger drive power in the towing mode control. Moreover, it is also possible to inhibit the BEV mode so as to always maintain the HEV mode in the towing mode control.

The vibration-suppression control portion 98 is configured to execute a vibration suppression control for causing the rotating machine MG to output a vibration suppression torque (vibration damping torque) Tinhi so as to suppress torsional vibration of the drive system, which causes vibration of the vehicle 10. Described specifically, for example, periodic rotational fluctuations of rotational speeds such as the output rotational speed No (that is the rotational speed) of the intermediate shaft 26 and rotational speeds of the rear and front output shafts 30, 31 are detected, and a vibration-suppression feedback control is executed to feedback-control the vibration suppression torque Tinhi of the rotating machine MG such that the detected rotational fluctuations are suppressed or reduced. It is also possible to feedback-control the vibration suppression torque Tinhi of the rotating machine MG such that a periodic rotational fluctuation of the MG rotational speed Nmg, which is caused by the torsional vibration of the drive system. When the rotating machine MG serves as the drive power source so as to generate a part of the requested drive torque Trdem, or the rotating machine MG is subjected to the regenerative control, the rotating machine MG is caused to generate the vibration suppression torque Tinhi in addition to the MG torque Tmg which is required to generate the part of the requested drive torque Trdem or which is required by the regenerative control. It is noted that each of the intermediate shaft 26, the rear and front output shafts 30, 31 and the rotating machine MG corresponds to “rotary member” recited in appended claims, and that each of speed sensors (such as the output speed sensor 74 and the MG speed sensor 76) that is configured to detect the rotational speed of a corresponding one of the shafts 26, 30, 31 and the rotating machine MG corresponds to “speed sensor” recited in the appended claims.

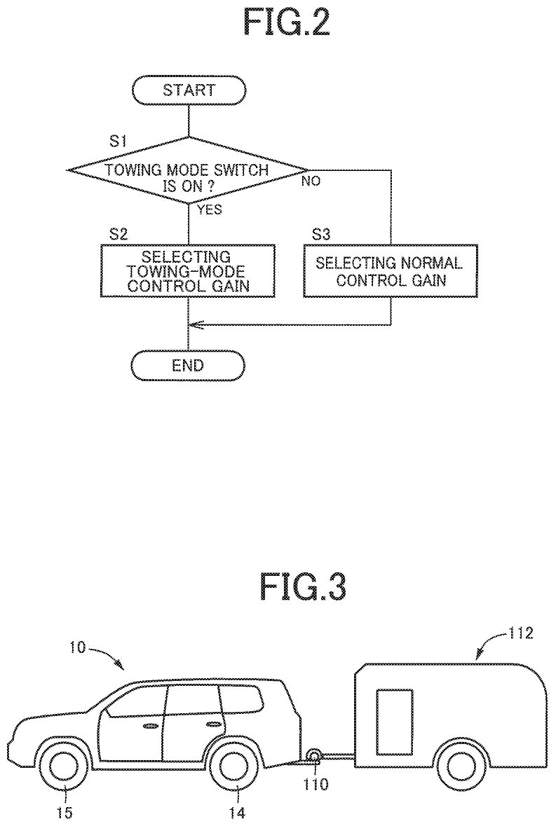

In the towing drive in which the vehicle 10 runs while towing the towed vehicle 112 (e.g., trailer), vibration could he generated between the vehicle 10 and the towed vehicle 112, apart from vibration generated in the vehicle 10 itself. If a resonance frequency of the vibration generated between the two vehicles 10, 112 is close to a resonance frequency of the vibration generated in the vehicle 10 itself, the vibration of the vehicle 10 could be increased due to resonance of the vibrations. Therefore, in accordance with a control routine shown by a flow char of FIG. 2, the vibration-suppression control portion 98 changes a control gain of the vibration-suppression feedback control, depending on whether the vehicle 10 is in a towing state or not, such that the control gain is made higher when the vehicle 10 is in the towing state, than when the vehicle 10 is not in the towing state. That is, when the vehicle 10 is in the towing mode, a vibration suppression capacity of the vibration-suppression feedback control is increased whereby the vibration of the vehicle 10 itself is quickly reduced.

The control routine shown in the flow chart of FIG. 2 is executed upon satisfaction of a predetermined condition, for example, upon detection of the periodic rotational fluctuation of the output rotational speed No. The control routine is initiated with step S1 that is implemented to determine whether the towing mode switch 82 has been operated to be placed in the ON state or not, namely, whether the towing mode signal Tow has been supplied to the electronic control apparatus 90 or not. The ON state of the towing mode switch 82, i.e., the supply of the towing mode signal Tow means that the vehicle 10 is in the towing state. No supply of the towing mode signal Tow with an OFF state of the towing mode switch 82 means that the vehicle 10 is not in the towing state. The determination at this step S1 may be made depending on whether the towing mode control is being executed by the towing-mode control portion 96 or not. It is also possible to provide, in addition to or in place of the towing mode switch 82, a towing detection device configured to mechanically detect presence of the towed vehicle 112, such that it is determined whether the vehicle 10 is in the towing state or not, based on the towing mode signal Tow (supplied from the towing mode switch 82) and/or a signal supplied from the towing detection device. The towing detection device is, for example, an ON-OFF switch that is to be mechanically placed in an ON state when the towed vehicle 112 is coupled to the vehicle 10. However, the towing detection device may be also configured to detect presence of the towed vehicle 112, based on a connection state of an electric connection terminal of the vehicle 10 to which an electric device of the towed vehicle 112 is to be connected, or based on analysis of an image taken by a camera configured to photograph a rear side of the vehicle 10. Further, it is also possible to determine whether the vehicle 10 is in the towing state or not, based on magnitude of a drive load (drive resistance) of the vehicle 10, which is obtained based on a vehicle drive state of the vehicle 10 such as the torques of the drive power sources (the engine 12 and the rotating machine MG), gear position established in the automatic transmission 24, road surface slope Φ and vehicle running speed V. When the acceleration of the vehicle 10 is low relative to the input torque Ttc of the torque converter 22 on a flat road in which the road surface slope Φ is substantially zero, it can be determined that the vehicle 10 is in the towing state with the drive load being large.

When an affirmative determination (YES) is made at step S1, namely, when the towing mode signal Tow has been supplied to the electronic control apparatus 90, step S2 is implemented to select a towing-mode control gain as the control gain of the vibration-suppression feedback control. When the towing mode signal Tow has not been supplied to the electronic control apparatus 90, step S3 is implemented to select, as the control gain of the vibration-suppression feedback control, a normal control gain for a normal state in which the towed vehicle 112 is not coupled to the vehicle 10. The towing-mode control gain selected at step S2 is higher than the normal control gain selected at step S3, so that the vibration suppression capacity of the vibration-suppression feedback control is increased whereby the vibration of the vehicle 10 itself is quickly reduced in the towing state of the vehicle 10. Therefore, in the towing drive, even if the vibration is generated between the vehicle 10 and the towed vehicle 112, it is possible to suppress increase of the vibration of the vehicle 10, which could be caused due to the resonance of the vibrations. The towing-mode control gain, which is selected at step S2, is set to a predetermined constant value that is determined, through an experimentation, simulation or the like, such that the torsional vibration of the drive system of the vehicle 10 can be quickly reduced with the towing-mode control gain being set to the predetermined constant value. It is noted that, where the vibration suppression control is to be executed for a plurality of kinds of vibrations of the vehicle 10, each of the normal control gain and the towing-mode control gain may be set to a value that is variable depending on the kinds of vibrations of the vehicle 10.

As described above, in the present embodiment, the vibration-suppression control portion 98, which is functionally included in the electronic control apparatus 90 of the vehicle 10, is configured to make the vibration suppression capacity of the vibration suppression control higher by making the control gain of the vibration-suppression feedback control of the rotating machine MG higher when the vehicle 10 is in the towing state with the towing mode being selected, than when the vehicle 10 is not in the towing state. Owing to execution of the vibration-suppression feedback control, the torsional vibration of the drive system, which is the vibration of the vehicle 10 itself, is appropriately reduced, so that it is possible to suppress increase of the vibration of the vehicle 10, which could be caused due to resonance of the vibration of the vehicle 10 itself and vibration generated between the vehicle 10 and the towed vehicle 112.

On the other hand, the increase of the control gain of the vibration suppression control of the rotating machine MG increases control width and change of the vibration suppression torque Tinhi and accordingly increases an electric power consumed by the rotating machine MG. However, although the control gain is increased by selection of the towing-mode control gain when the vehicle 10 is in the towing state, the control gain is kept low by selection of the normal control gain (that is lower than the towing-mode control gain) when the vehicle 10 is not in the towing state, so that increase of an electric cost due to the increase of the control gain, i.e., the increase of the vibration suppression capacity, can be suppressed to a minimally required amount.

Further, in the present embodiment, the vibration-suppression control portion 98 is configured to suppress the torsional vibration in the drive system of the vehicle 10, by feedback-controlling the vibration suppression torque Tinhi of the rotating machine MG, such that the control gain of the vibration-suppression feedback control is increased so as to increase the vibration suppression capacity when the vehicle 10 in the towing state. Therefore, when the vehicle 10 is in the towing state, the torsional vibration in the drive system of the vehicle 10 itself is quickly reduced, so that it is possible to suppress increase of the vibration of the vehicle 10, which could be caused due to the resonance of the vibrations, i.e., the vibration generated in the vehicle 10 itself and the vibration generated between the vehicle 10 and the towed vehicle 112.

It is to be understood that the embodiment described above is given for illustrative purpose only, and that the present invention may be embodied with various modifications and improvements which may occur to those skilled in the art.

### NOMENCLATURE OF ELEMENTS

10: hybrid electrically-operated vehicle (electrically-operated vehicle)
90: electronic control apparatus (control apparatus)
98: vibration-suppression control portion
112: towed vehicle
MG: rotating machine (electric motor, drive power source)

What is claimed is:

1. A control apparatus for an electrically-operated vehicle that includes an electric motor serving as one of at least one drive power source,
the control apparatus includes a vibration-suppression control portion configured to execute a vibration suppression control for causing the electric motor to output a vibration suppression torque by which vibration of the electrically-operated vehicle is to be suppressed,
wherein the vibration-suppression control portion is configured to determine whether the electrically-operated vehicle is in a towing state in which the electrically-operated vehicle runs while towing a towed vehicle, or not, and is configured to make a vibration suppression capacity of the vibration suppression control higher when determining that the electrically-operated vehicle is in the towing state, than when determining that the electrically-operated vehicle is not in the towing state.

2. The control apparatus according to claim 1,
wherein the vibration-suppression control portion is configured to execute a feedback control of the vibration suppression torque, and is configured to make a control gain of the feedback control higher when determining that the electrically-operated vehicle is in the towing state, than when determining that the electrically-operated vehicle is not in the towing state.

3. The control apparatus according to claim 1,
wherein the electrically-operated vehicle further includes: a power transmission apparatus configured to transmit a power from the at least one drive power source to drive wheels of the electrically-operated vehicle; and a speed sensor configured to detect a rotational speed of a rotary member that constitutes the power transmission apparatus, and
wherein the vibration-suppression control portion is configured to calculate the vibration suppression torque, based on fluctuation of the rotational speed detected by the speed sensor, such that the fluctuation of the rotational speed is reduced by the vibration suppression torque outputted by the electric motor.
